(19) United States
(12) Patent Application Publication
(10) Pub. No.: US 2026/0099700 A1
(43) Pub. Date: Apr. 9, 2026

(54) DIMENSIONALITY REDUCTION OF NEURAL NETWORKS INTERMEDIA FEATURE MAPS USING TWO-DIMENSIONAL PRINCIPAL COMPONENT ANALYSIS

(71) Applicant: Nokia Technologies Oy, Espoo (FI)

(72) Inventors: Homayun AFRABANDPEY, Espoo (FI); Alireza AMINLOU, Tampere (FI); Hamed REZAZADEGAN TAVAKOLI, Espoo (FI); Honglei ZHANG, Tampere (FI); Miska Matias HANNUKSELA, Tampere (FI)

(21) Appl. No.: 19/350,801

(22) Filed: Oct. 6, 2025

Related U.S. Application Data
(60) Provisional application No. 63/704,484, filed on Oct. 7, 2024.

(51) Int. Cl. G06N 3/0455; G06N 3/044

(52) U.S. Cl. CPC G06N 3/0455; G06N 3/044

(57) ABSTRACT

The embodiments concern a method comprising: decoding, from or along a bitstream, a mean matrix, a principal components matrix, and a row projection matrix; wherein the mean matrix corresponds to a mean of training data matrices, wherein the training data matrices are respective slices of at least one input tensor along a channel dimension of the at least one input tensor; wherein an original input matrix is a slice of the at least one input tensor along the channel dimension of the at least one input tensor, wherein the original input matrix has dimensions comprising at least a height and a width; wherein the at least one input tensor corresponds to at least one input image; wherein the row projection matrix comprises a concatenation of row projection vectors; and reconstructing the original input matrix by adding the mean matrix to a product comprising a multiplication of the principal components matrix with a transpose of the row projection matrix. The embodiments also concern technical equipment for implementing the method.

### TECHNICAL FIELD

The examples and non-limiting embodiments relate generally to a dimensionality reduction of neural networks intermediate feature maps using two-dimensional principal component analysis.

### BACKGROUND

It is known to perform data compression and data decompression in a multimedia system.

### BRIEF DESCRIPTION OF THE DRAWINGS

The foregoing embodiments and other features are explained in the following description, taken in connection with the accompanying drawings, wherein:

FIG. 1 shows an FCM pipeline.

FIG. 2 shows an overview of a feature coding test model.

FIG. 3 shows an overview of the cut in the feature pyramid network (FPN) backbone of the faster RCNN defined in FCM CTTC.

FIG. 4 shows training samples to be used to calculate basis vectors (BVs) for 2D²PCA.

FIG. 5 shows an overview of 2D²PCA for FCM feature reduction.

FIG. 6 shows channel-wise conversion of the input tensor to a matrix for 2D²PCA.

FIG. 7 shows an encoder according to an embodiment.

FIG. 8 shows a decoder according to an embodiment.

FIG. 9 is a block diagram illustrating a system in accordance with an example.

FIG. 10 is an example apparatus configured to implement the examples described herein.

FIG. 11 shows a representation of an example of non-volatile memory media used to store instructions that implement the examples described herein

FIG. 12 is an example method based on the examples described herein.

FIG. 13 is an example method based on the examples described herein.

FIG. 14 is an example method based on the examples described herein.

FIG. 15 is an example method based on the examples described herein.

### DETAILED DESCRIPTION OF EXAMPLE EMBODIMENTS

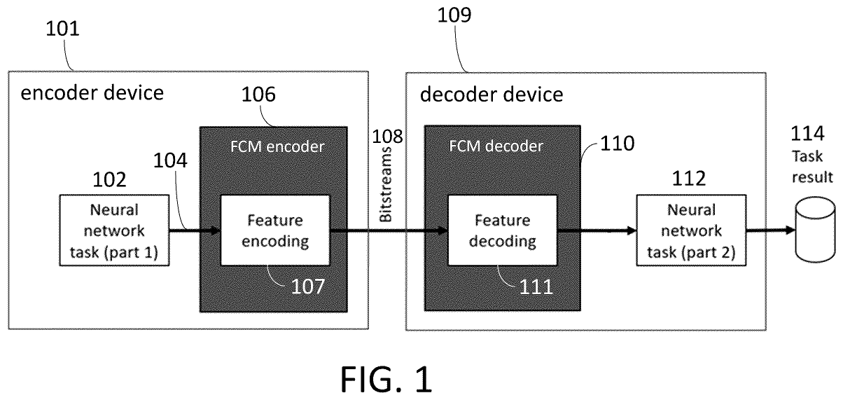

MPEG FCM issued a Call for Proposals (CfP) for compressing intermediate features of a deep Neural Network (NN) trained on an image/video dataset, such that decoded features are used to complete the execution of the task. The compression methods defined in the scope of the standard includes (but not limited to) feature reduction. In particular, the pipeline of the task is depicted in FIG. 1 and details are as follows (1-4):

1. A pre-defined NN trained end-to-end on a particular image/video dataset to accomplish a particular task from a predefined set of tasks, for example, object detection, instance segmentation, and object tracking. The model is then split into two parts, e.g., part 1 102 and part 2 112, using a split point defined based on a Common Training and Test Condition (CTTC).

2. The output 104 of part 1 102 of the NN is a set of tensors to be compressed and delivered to a decoder device 109 which has access to part 2 112 to accomplish the task.

Compression is done using the FCM encoder 106 which may contain a diverse set of feature encoding compression techniques 107 including NN and non-NN based feature reduction.

3. Compressed intermediate features are then encoded using NN or non-NN based inner codecs and the generated bitstream 108 is transferred to the device 109 with part 2 112. Part 1 102 of the neural network, FCM encoder, and feature encoding 107 are part of encoder device 101.

4. The received bitstream 108 is decoded (using FCM decoder 110 and feature decoding 111) to fed to the part 2 112 of the NN to accomplish the task and generate one or more task results 114.

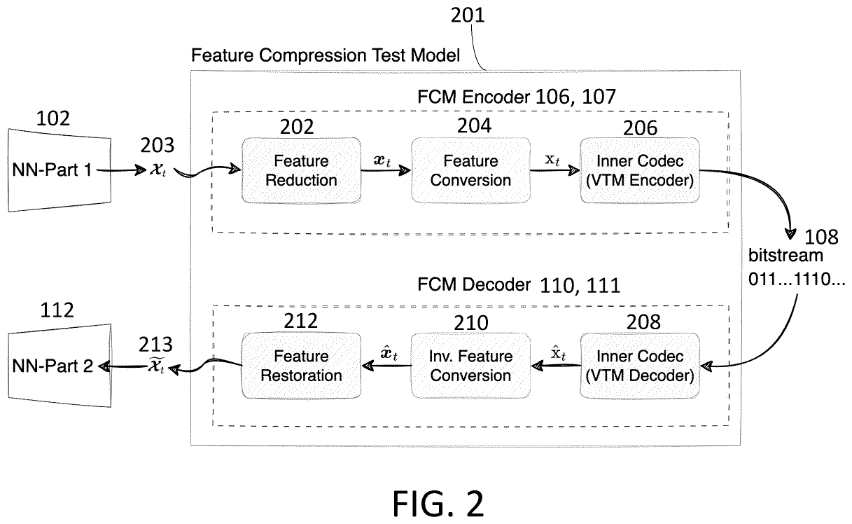

Referring to FIG. 2, according to an example CTTC, the FCM encoder 106 with feature encoding 107 contains three steps (1-3): 1) Feature reduction 202, 2) Feature conversion 204, 3) Inner codec 206. The hierarchy of these steps and their input/output are shown in FIG. 2. The FCM decoder 110 with feature decoding 111 contains three steps (1-3): 1) Inner codec 208, 2) Inverse feature conversion 210, 3) Feature restoration 212. FIG. 2 shows an overview of a feature coding test model 201.

In this disclosure, feature coding and feature compression may refer to the same concept and be used interchangeably.

Principal Component Analysis (PCA) is a statistical feature extraction and data representation technique that has been extensively used for feature reduction. Dimension reduction of an image deep feature may use PCA for reducing the dimensionality of intermediate features of a deep NN. Neural codes for image retrieval may apply PCA on the top layer representations of a pre-trained Convolutional Neural Network (CNN) to compress the representation and achieve state-of-the-art accuracy on image retrieval datasets. PCA may also be used for reducing the number of intermediate features in MPEG FCM.

To reduce the dimensionality of some data, PCA first vectorizes the data and then projects the vectorized high-dimensional data into a new low-dimensional space with orthogonal components called principal components. The principal components are simply linear combination of the original dimensions of the data and are constructed in such a way that they capture the maximum variance present in the data. Construction of the principal components is done by first calculating the eigenvectors and eigenvalues of the covariance matrix of the original vectorized data. Mathematically, consider being given a video containing in total N frames of size H×W. The goal is to reduce the dimensionality of the frames. PCA uses the N frames to learn the optimal subspace. It first vectorized the frames and pack them in a matrix X of size N×HW; that said each frame is now one row of the matrix and the dimensionality of the vectorized data is HW. Then the covariance matrix C of the vectorized data is calculated as follows:

$$c = \frac{{( X - μ )}^{T} \cdot ( X - μ )}{N - 1} ,$$

where μ∈ [symbol] is the mean vector and C∈

[symbol]

Using the covariance matrix C, PCA finds a set of size d of HW-dimensional vectors

$${\{ {a}_{i} ∈ {ℝ}^{H W \times 1} \}}_{i = 1}^{d}$$

called eigenvectors that map each row vector xᵢ∈ [symbol] of X, e.g., each training sample, to a new vector of principal components tᵢ=xᵢA where A∈ [symbol] is the matrix of eigenvectors, e.g., each column is one eigenvector, and tᵢ∈ [symbol] . To obtain dimensionality reduction, usually d<<HW.

Selection of the d eigenvectors is done by eigen-decomposition of the covariance matrix. For a matrix of size p×p, there could be in total p eigenvectors. In the eigen-decomposition process of the covariance matrix, corresponding to each eigenvector, a scalar value called eigenvalue is also calculated. Each eigenvalue determines how much variance is captured by its corresponding eigenvector. After calculation of the eigenvectors and eigenvalues of the covariance matrix, PCA sorts the eigenvectors based on the value of their corresponding eigenvalues in descending order and chooses the top d eigenvectors that explain x % of total variance in the data.

In PCA, as stated previously, the 2D data matrices are first transformed into 1D data vectors. This results in a high dimensional data vector space where it is difficult to evaluate the covariance matrix. For example, in MPEG FCM, one test case is object detection using SFU-HW dataset. In this case, the dimensionality of intermediate features in each channel could be as large as 320×200. By vectorizing a matrix with this size, the output vector is of size 64000×1. That said, the covariance matrix of this vector has a size of 64000×64000 which is very large and difficult (even impossible for some workstations) to calculate. The challenge is even harsher if the number of the training samples is large. Although, the eigenvectors and consequently the principal components can be calculated efficiently using the SVD technique and the process of generating the covariance matrix is avoided, still this does not imply that the eigenvectors can be evaluated accurately since they are statistically determined by the covariance matrix no matter what method is adopted for obtaining them.

The example embodiments described herein tackle the problem of feature dimension reduction for the purpose of feature compression for machine consumption. Described herein is a non-neural network based solution to that could achieve higher compressibility than PCA while being faster in compression calculation.

To deal with the aforementioned problem, two-dimensional PCA (2DPCA) is used for feature reduction in MPEG FCM. 2DPCA is based on 2D matrices rather than 1D vectors. That said, the data matrix does not need to be vectorized and the covariance matrix is constructed directly using data matrices. This way, the size of covariance matrix obtained in 2DPCA is much smaller than that of PCA. Therefore, 2DPCA has two important advantages over PCA: 1) It is easy to evaluate the covariance matrix and consequently calculation of the eigenvectors is done accurately, and 2) Calculation of the eigenvectors is much faster.

Assuming X∈ [symbol] as an input matrix to 2DPCA, it computes a set of optimal project vectors

$${\{ {a}_{i} ∈ {ℝ}^{W \times 1} \}}_{i = 1}^{d}$$

where d<<W such that:

$$\{ \begin{matrix}{\{ {a}_{i} \}}_{i = 1}^{d} = arg max J ( a ) \\ {a}_{i}^{T} {a}_{j} = 0 , i \neq j ; i , j = 1 , … , d\end{matrix}$$

where J(a)=a^{T}G_{X}a and G_{X} is the W×W covariance matrix of the training data calculated as follows:

$${G}_{X} = \frac{1}{N} {\sum }_{n = 1}^{N} {( {X}_{n} - \overline{X} )}^{T} ( {X}_{n} - \overline{X} )$$

where X̅ is the mean matrix of all training data matrices.

Similar to PCA, the d optimal projection vectors that maximize J(a) obtain by computing the d eigenvectors of G_{X} corresponding to the d largest eigenvalues. After finding the optimal set of projection vectors

$${\{ {a}_{i} \}}_{i = 1}^{d}$$

and concatenating them into a matrix A= [symbol] , the feature matrix X is projected into a new matrix Y called the matrix of principal components via Y=(X−X̅)A where Y∈ [symbol] .

In the decoder side, to reconstruct the original H×W matrix, what is needed is the projection matrix A, the matrix of principal components Y and the mean matrix X̅. Using these three matrices, the reconstructed matrix is calculated as \tilde{X}=YA^{T}+X̅.

2DPCA essentially works in the row direction of 2D data, that said, it reduces the row dimension of the data. In yet another version of 2DPCA, called 2D²PCA, both row and column dimensions can be reduced by finding two projection matrices Z∈ [symbol] and A∈ [symbol] for column and row dimensions, respectively, where m<<H and d<<W. That way, the matrix of principal components obtains as Y=Z^{T}(X−X̅)A∈ [symbol] . For reconstruction of the original H×W matrix, one needs four matrices, e.g., the projection matrices Z and A, the mean matrix X̅, and the matrix of principal components Y, using which the reconstructed matrix \tilde{X} obtains as \tilde{X}=ZYA^{T}+X̅.

### 2D²PCA for FCM

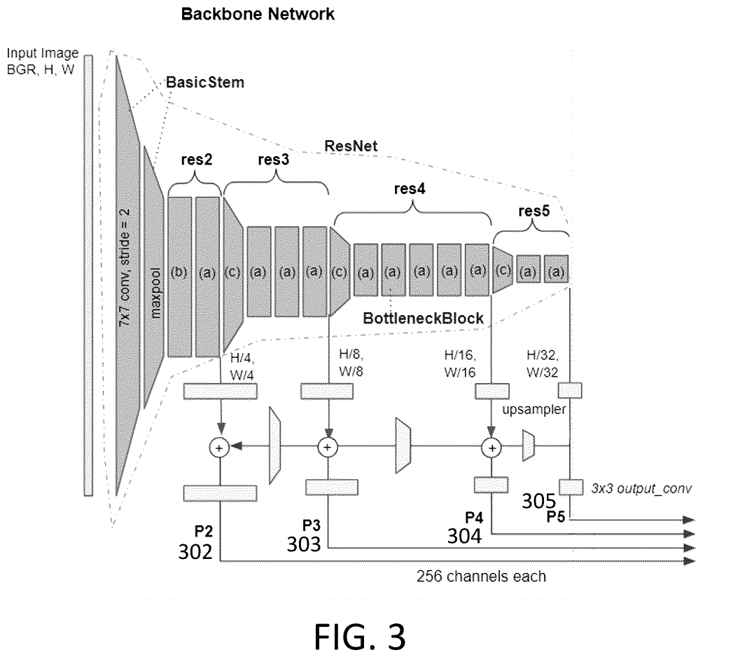

FIG. 3 shows an overview of the cut in the Feature Pyramid Network (FPN) backbone of the Faster RCNN in FCM CTTC.

Assuming there are in total N frames of a video, each frame is given to the deep neural network model as input and the intermediate feature of the neural network for the input is a set of feature tensors, the number of which depends on the split point. For example, one of the architectures used in the CTTC is the Faster RCNN from Detectron 2 framework with the cut point in the Feature Pyramid Network part as shown in FIG. 3. The cut generates 4 tensors, e.g., P2 302, P3 303, P4 304, and P5 305, of sizes 256×H/4×W/4, 256×H/8×W/8, 256×H/16×W/16, and 256×H/32×W/32, where H and W are the height of width of a input image. According to the FCM CTTC, the feature reduction method shall be applied to these feature tensors and the output of the feature reduction method shall be a single tensor or a set of tensors (refer to FIG. 2 in which Xₜ 203 refers to the set of tensors P2-P5 and xₜ 213 is the output tensor or a set of output tensors from the feature reduction method). It is to be understood embodiments are described in relation to tensors P2-P5 without loss of generality, and the embodiments may generally be realized with any neural network models, cut points, and tensors (resulting by the choice of the neural network model and cut points).

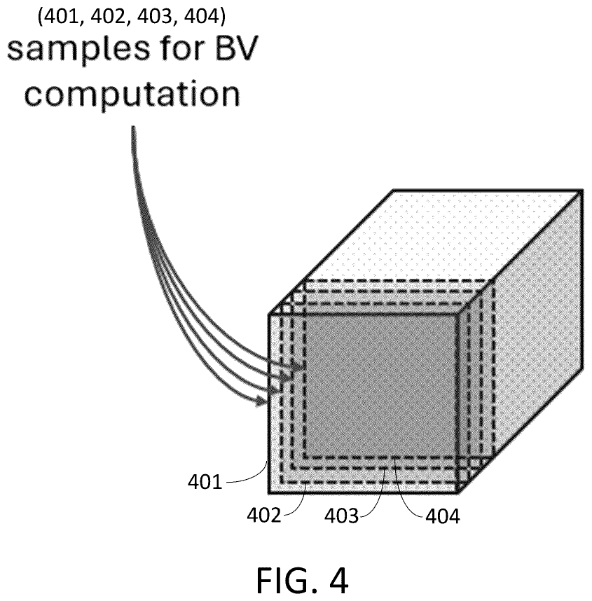

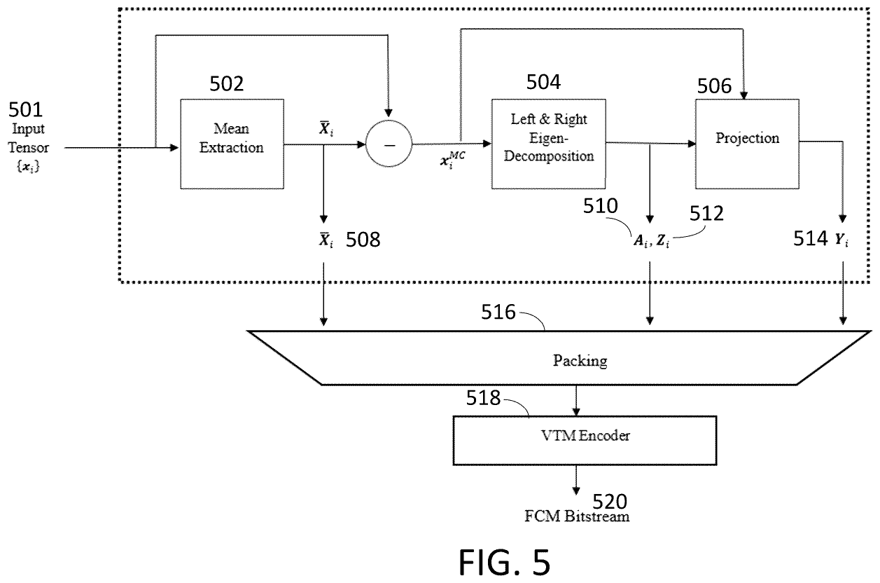

To apply 2D²PCA on the intermediate feature tensors resulted from the cut in a deep neural network, what is first decided on is a direction to apply it. For this, among different options, 2D²PCA is applied on the set of feature matrices (including feature matrix 401 of a first channel, feature matrix 402 of a second channel, feature matrix 403 of a third channel, and feature matrix 404 of a fourth channel) of all channels as shown in FIG. 4. This means, the matrices of each channel (256 in the case of Faster RCNN) are used as the training data to calculate two projection matrices for that particular tensor. Other options are discussed in embodiments. Given these details, the encoder side process of 2D²PCA follows the process shown in FIG. 5.

Thus, FIG. 4 illustrates training samples to be used to calculate Basis Vectors (BVs) for 2D²PCA, where the training samples include feature matrix 401 of a first channel, feature matrix 402 of a second channel, feature matrix 403 of a third channel, and feature matrix 404 of a fourth channel.

FIG. 5 shows an overview of 2D²PCA for FCM feature reduction, including processing of input tensor 501 (where in an example input tensor 501 is one tensor of the set of tensors Xₜ 203) with mean extraction 502, left and right eigen-decomposition 504, and projection 506. Mean extraction 502 generates mean matrix X̅ 508 for an input tensor 501, left and right eigen-decomposition 504 of the mean matrix X̅ 508 or data derived from the mean matrix X̅ 508 generates row projection matrix A 510 and column projection matrix Z 512, and projection 506 generates principal component matrix Y 514.

The mean matrix X̅ 508, the row projection matrix A 510, the column projection matrix Z 512, and the principal component matrix Y 514 are packed by packing 516, and the output of the packing 516 is provided to VTM Encoder 518 which generates FCM bitstream 520.

As the example cut point shown in FIG. 3, for each tensor P2-P5 (namely P2 302, P3 303, P4 304, and P5 305), the input to the 2D²PCA is a set of 256 matrices. That said, the output of 2D²PCA for each tensor in CE2 contains three matrices, i.e., two projection matrices A 510 and Z 512, and a mean matrix X̅ 508, and one tensor of principal components Y 514.

Various embodiments to process and encode the two projection matrices A 510 and Z 512, the mean matrix X̅ 508, and the tensor of principal components Y 514 for each tensor P2-P5 (P2 302, P3 303, P4 304, and P5 305), which are collectively referred to as the output of 2D²PCA are described below.

In an embodiment, the output of 2D²PCA is spatially packed onto a picture. The picture is encoded with any video or image encoder, such as the VTM reference encoder of the VVC standard.

In the following embodiments, the output of 2D²PCA is spatially packed onto more than one picture. In an embodiment, each set of matrices and tensors of the output of 2D²PCA that have the same dimensions are spatially packed onto a picture. In an alternative embodiment, each set of matrices and tensors of the output of 2D²PCA that have dimensions that are integer multiples of each other are spatially packed onto a picture. In yet another alternative, each type of matrix or tensor in the output of 2D²PCA is spatially packed onto a picture. In an embodiment, the resulting pictures are temporally interleaved, and the sequence of pictures is encoded with any video or image encoder, such as the VTM reference encoder of the VVC standard. In an embodiment, the resulting pictures are encoded in separate scalability layers of a multi-layer video or image encoder.

In an embodiment, one or more matrices and/or tensors of the output of 2D²PCA is spatially packed onto one or more pictures and encoded by a video/image encoder as described above, and other matrices and/or tensors of the output of 2D²PCA are encoded by other means, such as an entropy encoder, which may for example be a context-adaptive binary arithmetic coder.

The FCM bitstream 520 may be sent to the decoder.

### PoC Results

To test the performance of 2DPCA and PCA in terms of processing time and output size, a proof of concept (PoC) test was run. In this PoC test, the ORL dataset was adopted. The ORL dataset is a publicly available dataset with face images of 38 persons each with 10 images of size 112×92. For each person, 8 images are used for training (in total 304 training images) and the rest are kept for test. The task is face recognition and the input to the algorithms is a tensor of size 304×112×92. The metrics used in this test are: recognition accuracy, time in second it takes to train and get the principal components, and the size of the outputs generated by each algorithm when compressed using np.zip( ). Each algorithm is set to select k eigenvectors that preserve 90% of the total variance in the data.

Table 1 demonstrates the results.

TABLE 1
Comparison of 2DPCA with two different implementations
with PCA in a face recognition task

| | | | | Zipped |
|---|---|---|---|---|
| | Accuracy | Time | | Size |
| | (%) | (s) | Output Shapes | (KB) |
| 2D²PCA | 98.68 | 0.17 | (304 × 16 × 15) + (92 × 15) + | 571 |
| | | | (112 × 16) = 76,132 | |
| 2DPCA | 97.36 | 0.15 | (304 × 112 × 15) + (92 × 15) = | 3,836 |
| | | | 512,100 | |
| PCA | 93.42 | 1.6 | (221 × 304) + (10304 × 221) = | 17,546 |
| | | | 2,334,368 | |

Two different versions of 2DPCA are implemented, named as 2DPCA and 2D²PCA in the table. The difference between 2DPCA and 2D²PCA is that 2DPCA essentially works in the row direction of the images while 2D²PCA works in both row and column directions. It is seen in the table that 2D²PCA outperforms the other two methods in terms of its compressed output size and the recognition accuracy. 2DPCA stands in the 2^{nd} place with a recognition accuracy marginally below that of 2D²PCA while the compressed output size is 7 times worse than 2D²PCA. The training time of 2DPCA is marginally better than 2D²PCA. PCA is the worst performing approach with compressed output size being 30 times larger than 2D²PCA and 5 times larger than 2DPCA while its recognition accuracy is ˜5% less that the other two methods. Finally, the training time of PCA is also 10 times higher than the two alternatives.

### EMBODIMENTS

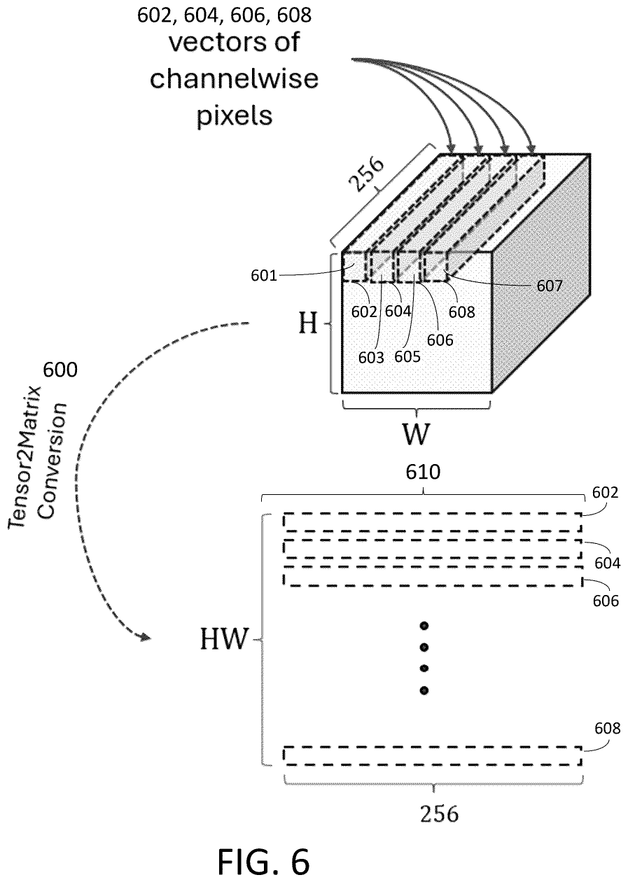

Given multiple tensors with different spatial resolutions, where the width and height of a higher resolution is a multiple of the width and height of the tensor with the lowest resolution, a higher resolution tensor may be split into multiple low-resolution tensors in a interleave manner. 2DPCA or 2D2PCA may be applied to the samples from the generated low-resolution tensors. For example, a P2 layer tensor with the shape of 8 W*8H may be split into 64 W*H tensors. 2DPCA or 2D2PCA may be applied to the samples of the 64 generated tensors with resolution of W*H from P2 layer and the P5 layer tensor with the same of W*H.
In an embodiment, dimension reduction may be performed in block-based manner. This means that a higher resolution tensor may be spatially divided into multiple smaller tensors, and 2DPCA or 2D2PCA may be applied to the samples of smaller tensors. For example, a P2 latent tensor with the shape of 8W×8H may be split into 64 tensors with the size of W*H, or may be divided into W*H tensors of size 8*8. For each smaller tensor sP2[m,n], each sample may be determined as below: P2[m,n](x,y)=P2(M*m+x, N*n+y).
In another embodiment, tensors with different resolutions may be grouped based on the resolution. Projection matrices may be derived from each group. For example, tensors from P2 and P3 may be grouped together to derive one set of projection matrices.
In one embodiment, 2D²PCA is applied channel-wise (similar to online PCA) in which basis vectors decorrelate along the channel dimension. That means, for each tensor, the first pixel 601 of all channels forms a vector of size 256 (602) in the case of Faster RCNN shown in FIG. 3, the second pixel 603 forms another vector of all channel slices (604) and of size 256, the third pixel 605 forms another vector (606) of all channel slices and of size 256, the fourth pixel 607 forms another vector 608 of all channel slices and of size 256, etc. These vectors are then combined into a matrix 610 of size HW×256 which is given to the 2D²PCA as input. In this way, the output of 2D²PCA for each tensor is four matrices: a mean matrix, two projection matrices, and a principal component matrix. Thus FIG. 6 shows channel-wise conversion 600 of the input tensor to a matrix for 2D²PCA.
In another embodiment, for each tensor resulted from the split point, 2DPCA is combined with spatial sparsity on features to generate sparse principal components. A sparse principal component can be better compressed, e.g. by a video encoder, such as the reference encoder of the VVC standard, compared to its non-sparse counterpart.
In another embodiment, 2D²PCA is applied channel-wise only to intra frames and use the projected matrices for all inter frames.
In another embodiment, the 2D2PCA may apply to a codebook, obtained or updated during encoding process in an online fashion, where the codebook represents the features to be decoded. During decoding processes, the code book may be decompressed and become available at intervals than each instance of communication. The decoded codebook may be complemented with the indices provided to allow reconstruction of the original features after reconstructing the codebook.

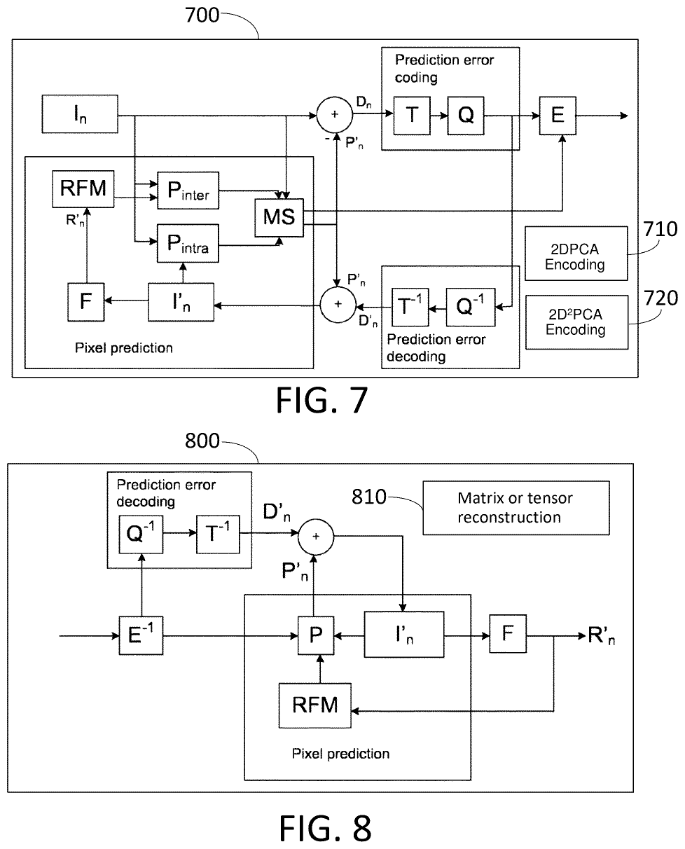

FIG. 7 shows an encoder 700 according to an embodiment. FIG. 7 illustrates an image to be encoded (Iⁿ), a predicted representation of an image block (P′ⁿ), a prediction error signal (Dⁿ), a reconstructed prediction error signal (D′ⁿ), a preliminary reconstructed image (I′ⁿ), a final reconstructed image (R′ⁿ), a transform (T) and inverse transform (T⁻¹), a quantization (Q) and inverse quantization (Q⁻¹), entropy encoding (E), a reference frame mernory (RFM), inter prediction (P^{inter}), intra prediction (P^{inter}), mode selection (MS) and filtering (F). [0062]2DPCA encoding 710 implements the examples described herein related to 2DPCA encoding. 2D²PCA encoding 720 implements the examples described herein related to 2D²PCA encoding.

FIG. 8 shows a decoder 800 according to an embodiment. FIG. 8 illustrates a predicted representation of an image block (P′ⁿ), a reconstructed prediction error signal (D′ⁿ) a preliminary reconstructed image (I′ⁿ), a final reconstructed image (R′ⁿ), an inverse transform (T⁻¹), an inverse quantization (Q⁻¹), an entropy decoding (E¹), a reference frame memory (RFM), a prediction (either inter or intra) (P), and filtering (F).

Matrix or tensor reconstruction 810 implements the examples described herein related to matrix or tensor reconstruction 810.

A video encoder transforms the input video into a compressed representation suited for storage/transmission and a video decoder decompresses the compressed video representation back into a viewable form. Typically, an encoder discards some information in the original video sequence in order to represent the video in a more compact form (that is, at lower bitrate).

A video encoder may encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, e.g., the difference between the predicted block of pixels and the original block of pixels, is coded. This is typically done by transforming the difference in pixel values using a specified transform (e.g., Discrete Cosine Transform (DCT) or a variant of it), quantizing the coefficients and entropy coding the quantized coefficients. By varying the fidelity of the quantization process, the encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures (a.k.a. reference pictures).

Intra prediction utilizes the fact that adjacent pixels within the same picture are likely to be correlated. Intra prediction can be performed in spatial or transform domain, e.g., either sample values or transform coefficients can be predicted. Intra prediction is typically exploited in intra coding, where no inter prediction is applied.

An intra picture may be defined as a coded picture that is decoded using intra prediction only, or in other words, does not make use of inter prediction in decoding. An intra picture may be interchangeably called an intra frame.

An inter picture may be defined as a coded picture whose decoding may include intra prediction and inter prediction. An inter picture may be interchangeably called an inter frame.

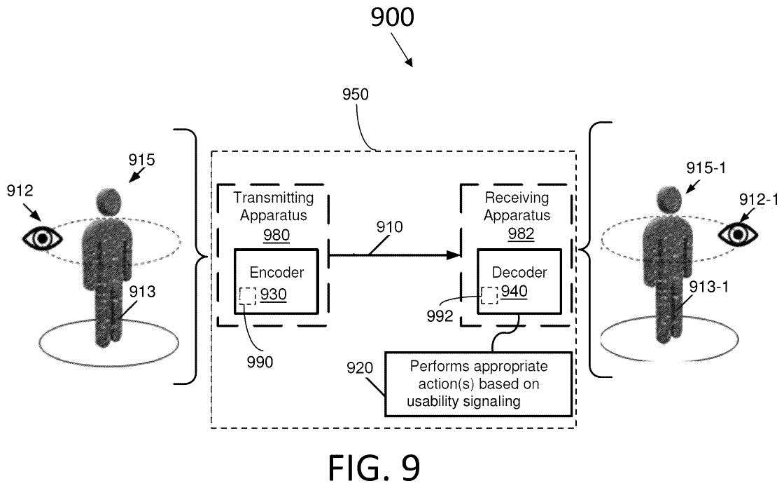

FIG. 9 is a block diagram illustrating a system 900 in accordance with several examples. In an example, the encoder 930 is used to encode an image or video from the scene 915, and the encoder 930 is implemented in a transmitting apparatus 980. The encoder 930 produces a bitstream 910 comprising signaling that is received by the receiving apparatus 982, which implements a decoder 940. The encoder 930 sends the bitstream 910 that comprises the herein described signaling. The decoder 940 forms the image or video for the scene 915-1, and the receiving apparatus 982 would present this to the user, e.g., via a smartphone, television, or projector among many other options.

In some examples, the transmitting apparatus 980 and the receiving apparatus 982 are at least partially within a common apparatus, and for example are located within a common housing 950. In other examples the transmitting apparatus 980 and the receiving apparatus 982 are at least partially not within a common apparatus and have at least partially different housings. Therefore in some examples, the encoder 930 and the decoder 940 are at least partially within a common apparatus, and for example are located within a common housing 950. For example the common apparatus comprising the encoder 930 and decoder 940 implements a codec. In other examples the encoder 930 and the decoder 940 are at least partially not within a common apparatus and have at least partially different housings, but when together still implement a codec.

In some examples, 3D media from the capture (e.g., volumetric capture) at a viewpoint 912 of the scene 915, which includes a person 913) is converted via projection to a series of 2D representations with occupancy, geometry, attributes and/or displacements.

Additional atlas information is also included in the bitstream to enable inverse reconstruction. For decoding, the received bitstream 910 is separated into its components with atlas information; occupancy, geometry, displacement, and attribute 2D representations. A 3D reconstruction is performed to reconstruct the scene 915-1 created looking at the viewpoint 912-1 with a “reconstructed” person 913-1. The “−1” are used to indicate that these are reconstructions of the original. As indicated at 920, the decoder 940 performs an action or actions based on the received signaling.

Encoding 990 performs the examples described herein related to 2DPCA encoding and 2D²PCA encoding. Decoding 992 performs the examples described herein related to matrix or tensor reconstruction.

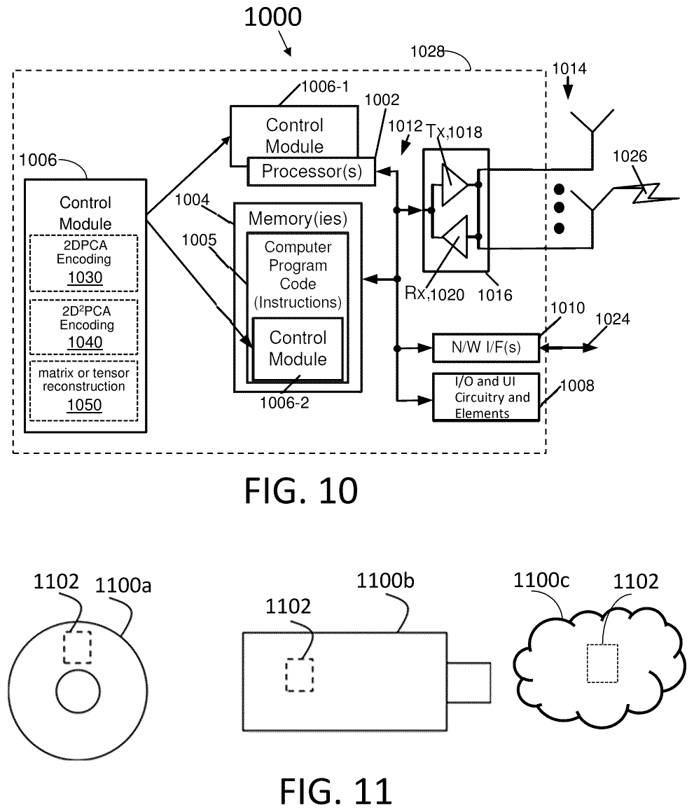

FIG. 10 is an example apparatus 1000, which may be implemented in hardware, configured to implement the examples described herein. The apparatus 1000 comprises at least one processor 1002 (e.g., an FPGA and/or CPU and/or GPU), one or more memories 1004 including computer program code 1005, the computer program code 1005 having instructions to carry out the methods described herein, wherein the at least one memory 1004 and the computer program code 1005 are configured to, with the at least one processor 1002, cause the apparatus 1000 to implement circuitry, a process, component, module, or function (implemented with control module 1006) to implement the examples described herein.

Apparatus 1000 may be a smartphone, personal digital device or assistant, smart television, laptop, pad, tablet, head-mounted display (HMD), or other user device or terminal device. The memory 1004 may be a non-transitory memory, a transitory memory, a volatile memory (e.g. RAM), or a non-volatile memory (e.g., ROM).

Optionally included 2DPCA encoding 1030 implements the examples described herein related to 2DPCA encoding. Optionally included 2D²PCA encoding 1040 implements the examples described herein related to 2D²PCA encoding. Optionally included matrix or tensor reconstruction 1050 implements the decoding related examples described herein related to matrix or tensor reconstruction.

The apparatus 1000 includes a display and/or I/O interface 1008, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1000 includes one or more communication e.g. network (N/W) interfaces (I/F(s)) 1010. The communication I/F(s) 1010 may be wired and/or wireless and communicate over the Internet/other network(s) via any communication technique including via one or more links 1024. The communication I/F(s) 1010 may comprise one or more transmitters or one or more receivers.

The transceiver 1016 comprises one or more transmitters 1018 and one or more receivers 1020. The transceiver 1016 and/or communication I/F(s) 1010 may comprise standard well-known components such as an amplifier, filter, frequency-converter, (de)modulator, and encoder/decoder circuitries and one or more antennas, such as antennas 1014 used for communication over wireless link 1026.

The control module 1006 of the apparatus 1000 comprises one of or both parts 1006-1 and/or 1006-2, which may be implemented in a number of ways. The control module 1006 may be implemented in hardware as control module 1006-1, such as being implemented as part of the one or more processors 1002. The control module 1006-1 may be implemented also as an integrated circuit or through other hardware such as a programmable gate array. In another example, the control module 1006 may be implemented as control module 1006-2, which is implemented as computer program code (having corresponding instructions) 1005 and is executed by the one or more processors 1002. For instance, the one or more memories 1004 store instructions that, when executed by the one or more processors 1002, cause the apparatus 1000 to perform one or more of the operations as described herein. Furthermore, the one or more processors 1002, one or more memories 1004, and example algorithms (e.g., as flowcharts and/or signaling diagrams), encoded as instructions, programs, or code, are means for causing performance of the operations described herein.

The apparatus 1000 to implement the functionality of control 1006 may correspond to any of the apparatuses depicted herein. Alternatively, apparatus 1000 and its elements may not correspond to any of the other apparatuses depicted herein, as apparatus 1000 may be part of a self-organizing/optimizing network (SON) node or other node, such as a node in a cloud.

The apparatus 1000 may also be distributed throughout the network including within and between apparatus 1000 and any network element (such as a base station and/or terminal device and/or user equipment).

Interface 1012 enables data communication and signaling between the various items of apparatus 1000, as shown in FIG. 10. For example, the interface 1012 may be one or more buses such as address, data, or control buses, and may include any interconnection mechanism, such as a series of lines on a motherboard or integrated circuit, fiber optics or other optical communication equipment, and the like. Computer program code (e.g. instructions) 1005, including control 1006 may comprise object-oriented software configured to pass data or messages between objects within computer program code 1005.

Computer program code (e.g. instructions) 1005, including control 1006 may comprise procedural, functional, or scripting code. The apparatus 1000 need not comprise each of the features mentioned, or may comprise other features as well. The various components of apparatus 1000 may at least partially reside in a common housing 1028, or a subset of the various components of apparatus 1000 may at least partially be located in different housings, which different housings may include housing 1028.

FIG. 11 shows a schematic representation of non-volatile memory media 1100a (e.g. computer/compact disc (CD) or digital versatile disc (DVD)) and 1100b (e.g. universal serial bus (USB) memory stick) and 1100c (e.g. cloud storage for downloading instructions and/or parameters 1102 or receiving emailed instructions and/or parameters 1102) storing instructions and/or parameters 1102 which when executed by a processor allows the processor to perform one or more of the operations of the methods described herein.

Instructions and/or parameters 1102 may represent or correspond to a non-transitory computer readable medium.

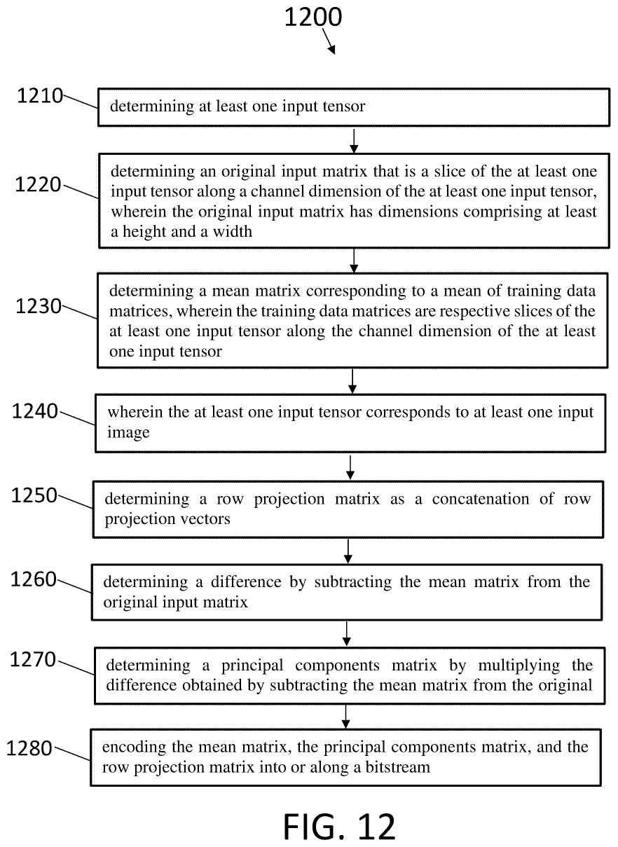

FIG. 12 is an example method 1200 based on the examples described herein. At 1210, the method includes determining at least one input tensor. At 1220, the method includes determining an original input matrix that is a slice of the at least one input tensor along a channel dimension of the at least one input tensor, wherein the original input matrix has dimensions comprising at least a height and a width. At 1230, the method includes determining a mean matrix corresponding to a mean of training data matrices, wherein the training data matrices are respective slices of the at least one input tensor along the channel dimension of the at least one input tensor. At 1240, the method includes wherein the at least one input tensor corresponds to at least one input image. At 1250, the method includes determining a row projection matrix as a concatenation of row projection vectors. At 1260, the method includes determining a difference by subtracting the mean matrix from the original input matrix. At 1270, the method includes determining a principal components matrix by multiplying the difference obtained by subtracting the mean matrix from the original input matrix with the row projection matrix. At 1280, the method includes encoding the mean matrix, the principal components matrix, and the row projection matrix into or along a bitstream. Method 1200 may be performed with encoder 700, transmitting apparatus 980 with encoder 930, or apparatus 1000.

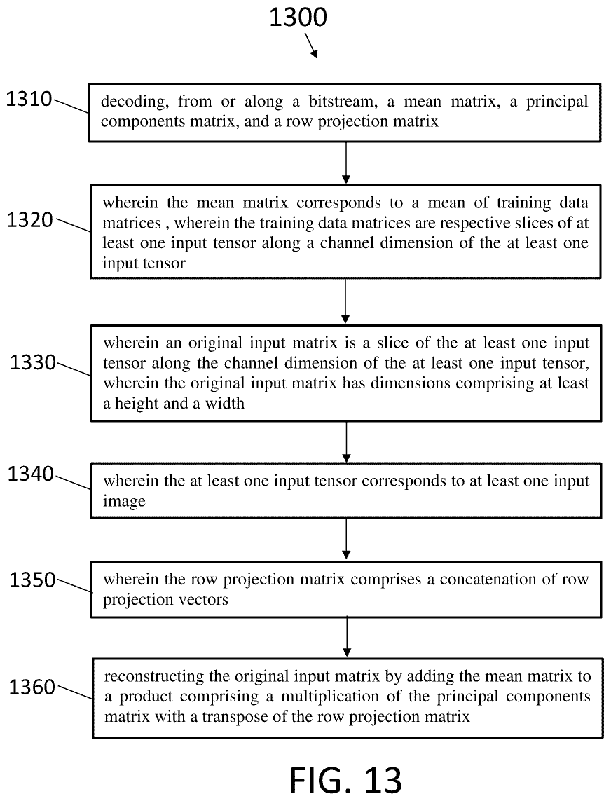

FIG. 13 is an example method 1300 based on the examples described herein. At 1310, the method includes decoding, from or along a bitstream, a mean matrix, a principal components matrix, and a row projection matrix. At 1320, the method includes wherein the mean matrix corresponds to a mean of training data matrices, wherein the training data matrices are respective slices of at least one input tensor along a channel dimension of the at least one input tensor. At 1330, the method includes wherein an original input matrix is a slice of the at least one input tensor along the channel dimension of the at least one input tensor, wherein the original input matrix has dimensions comprising at least a height and a width. At 1340, the method includes wherein the at least one input tensor corresponds to at least one input image. At 1350, the method includes wherein the row projection matrix comprises a concatenation of row projection vectors. At 1360, the method includes reconstructing the original input matrix by adding the mean matrix to a product comprising a multiplication of the principal components matrix with a transpose of the row projection matrix. Method 1300 may be performed with decoder 800, receiving apparatus 982 with decoder 940, or apparatus 100.

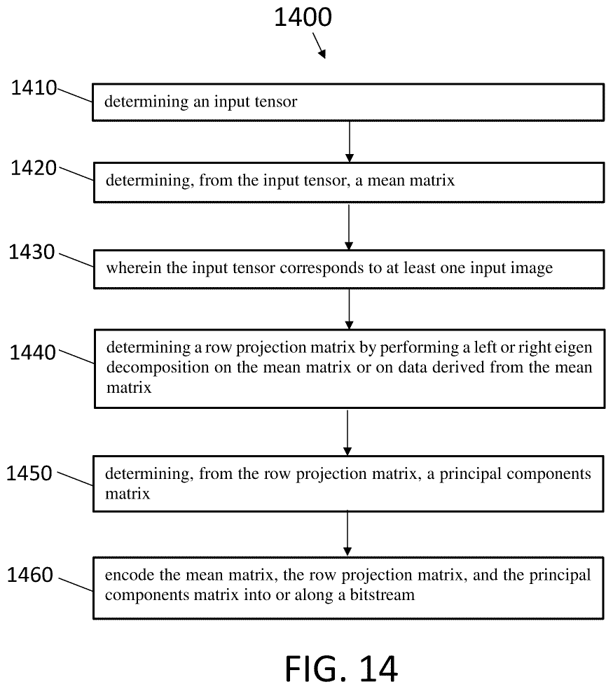

FIG. 14 is an example method 1400 based on the examples described herein. At 1410, the method includes determining an input tensor. At 1420, the method includes determining, from the input tensor, a mean matrix. At 1430, the method includes wherein the input tensor corresponds to at least one input image. At 1440, the method includes determining a row projection matrix by performing a left or right eigen decomposition on the mean matrix or on data derived from the mean matrix. At 1450, the method includes determining, from the row projection matrix, a principal components matrix. At 1460, the method includes encode the mean matrix, the row projection matrix, and the principal components matrix into or along a bitstream. Method 1400 may be performed with encoder 700, transmitting apparatus 980 with encoder 930, or apparatus 1000.

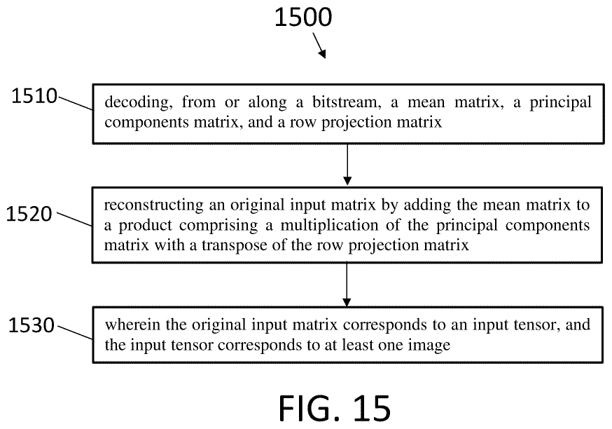

FIG. 15 is an example method 1500 based on the examples described herein. At 1510, the method includes decoding, from or along a bitstream, a mean matrix, a principal components matrix, and a row projection matrix. At 1520, the method includes reconstructing an original input matrix by adding the mean matrix to a product comprising a multiplication of the principal components matrix with a transpose of the row projection matrix. At 1530, the method includes wherein the original input matrix corresponds to an input tensor, and the input tensor corresponds to at least one image. Method 1300 may be performed with decoder 800, receiving apparatus 982 with decoder 940, or apparatus 100.

The following examples are provided and described herein.

Example 1. An apparatus including: at least one processor; and at least one memory storing instructions that, when executed by the at least one processor, cause the apparatus at least to: determine at least one input tensor; determine an original input matrix that is a slice of the at least one input tensor along a channel dimension of the at least one input tensor, wherein the original input matrix has dimensions comprising at least a height and a width; determine a mean matrix corresponding to a mean of training data matrices, wherein the training data matrices are respective slices of the at least one input tensor along the channel dimension of the at least one input tensor; wherein the at least one input tensor corresponds to at least one input image; determine a row projection matrix as a concatenation of row projection vectors; determine a difference by subtracting the mean matrix from the original input matrix; determine a principal components matrix by multiplying the difference obtained by subtracting the mean matrix from the original input matrix with the row projection matrix; and encode the mean matrix, the principal components matrix, and the row projection matrix into or along a bitstream.

Example 2. The apparatus of example 1, wherein the apparatus is further caused to: determine a number of the row projection vectors, where each row projection vector has a dimension corresponding to the width of the original input matrix; wherein the number of the row projection vectors comprises a row dimension of the row projection matrix; wherein the row dimension of the row projection matrix is smaller than the width of the original input matrix; wherein the row projection matrix comprises dimensions corresponding to the width of the original input matrix and the row dimension.

Example 3. The apparatus of example 2, wherein the principal components matrix comprises a dimension corresponding to at least the row dimension of the row projection matrix.

Example 4. The apparatus of any of examples 1 to 3, wherein the apparatus is further caused to determine a row projection vector of the row projection vectors with: determining at least one parameter that maximizes a transpose of the row projection vector multiplied with a training data covariance matrix multiplied with the row projection vector; wherein the training data covariance matrix is a square matrix comprising dimensions corresponding to the width of the original input matrix; wherein the transpose of the row projection vector multiplied with another row projection vector of the row projection vectors is equal to zero, wherein the another row projection vector is any of the row projection vectors other than the row projection vector, such that the row projection vector is orthogonal to the other row projection vectors.

Example 5. The apparatus of example 4, wherein apparatus is further caused to determine the training data covariance matrix with: determining, for each training data matrix of the training data matrices, a product comprising a transpose of the training data matrix minus the mean matrix multiplied with the training data matrix minus the mean matrix; wherein the training data covariance matrix comprises a sum of the products divided by a number of the training data matrices.

Example 6. The apparatus of any of examples 4 to 5, wherein determining the at least one parameter that maximizes the transpose of the row projection vector multiplied with the training data covariance matrix multiplied with the row projection vector comprises computing a number of eigenvectors of the training data covariance matrix corresponding to a number of largest eigenvalues, wherein the number of eigenvectors is a row dimension of the row projection matrix, and wherein the number of largest eigenvalues is the row dimension of the row projection matrix, wherein the row dimension of the row projection matrix is smaller than the width of the original input matrix.

Example 7. The apparatus of any of examples 1 to 6, wherein the mean matrix and the row projection matrix are derived from one frame, and the mean matrix and the row projection matrix are used for another frame different from the one frame, such that the mean matrix and the row projection matrix are derived from an intra frame, and the mean matrix and the row projection matrix are used for inter frames.

Example 8. The apparatus of any of examples 1 to 7, wherein the apparatus is further caused to: determine a column projection matrix as a concatenation of column projection vectors; and encode the column projection matrix into or along the bitstream.

Example 9. The apparatus of example 8, wherein the principal components matrix is further determined by multiplying a transpose of the column projection matrix with: the difference obtained by subtracting the mean matrix from the original input matrix, and with the row projection matrix.

Example 10. The apparatus of any of examples 8 to 9, wherein the apparatus is further caused to: determine a number of the column projection vectors, where each column projection vector has a dimension corresponding to the height of the original input matrix; wherein the number of the column projection vectors comprises a column dimension of the column projection matrix; wherein the column dimension of the column projection matrix is smaller than the height of the original input matrix; wherein the column projection matrix comprises dimensions corresponding to the height of the original input matrix and the column dimension.

Example 11. The apparatus of example 10, wherein the principal components matrix comprises a dimension corresponding to at least the column dimension of the column projection matrix.

Example 12. The apparatus of any of examples 8 to 11, wherein the apparatus is further caused to determine a column projection vector of the column projection vectors with: determining at least one parameter that maximizes a transpose of the column projection vector multiplied with a training data covariance matrix multiplied with the column projection vector; wherein the training data covariance matrix is a square matrix comprising dimensions corresponding to the height of the original input matrix; wherein the transpose of the column projection vector multiplied with another column projection vector of the number of column projection vectors is equal to zero, wherein the another column projection vector is any of the column projection vectors other than the column projection vector, such that the column projection vector is orthogonal to the other column projection vectors.

Example 13. The apparatus of example 12, wherein apparatus is further caused to determine the training data covariance matrix with: determining, for each training data matrix of the training data matrices, a product comprising a transpose of the training data matrix minus the mean matrix multiplied with the training data matrix minus the mean matrix; wherein the training data covariance matrix comprises a sum of the products divided by a number of the training data matrices.

Example 14. The apparatus of any of examples 12 to 13, wherein determining the at least one parameter that maximizes the transpose of the column projection vector multiplied with the training data covariance matrix multiplied with the column projection vector comprises computing a number of eigenvectors of the training data covariance matrix corresponding to a number of largest eigenvalues, wherein the number of eigenvectors is a column dimension of the column projection matrix, and wherein the number of largest eigenvalues is the column dimension of the column projection matrix, wherein the column dimension of the column projection matrix is smaller than the height of the original input matrix.

Example 15. The apparatus of any of examples 8 to 14, wherein the mean matrix, the row projection matrix, and the column projection matrix are derived from one frame, and the mean matrix, the row projection matrix, and the column projection matrix are used for another frame different from the one frame, such that the mean matrix, the row projection matrix, and the column projection matrix are derived from an intra frame, and the mean matrix, the row projection matrix, and the column projection matrix are used for inter frames.

Example 16. The apparatus of any of examples 1 to 15, wherein the apparatus is further caused to: combine channelwise pixel vectors into a matrix of channelwise pixel vectors, wherein each channelwise pixel vector of the channelwise pixel vectors has a size; wherein a number of the channelwise pixel vectors in the matrix of channelwise pixel vectors corresponds to the height of the original input matrix multiplied by the width of the original input matrix; wherein the at least one input tensor comprises the matrix of channelwise pixel vectors.

Example 17. The apparatus of example 16, wherein the size of each channelwise pixel vector corresponds to the channel dimension of the at least one input tensor.

Example 18. The apparatus of any of examples 16 to 17, wherein the at least one input tensor has a first dimension comprising HxW and a second dimension comprising C, where C is the channel dimension of the at least one input tensor, and the original input matrix has a first dimension comprising HxW and a second dimension comprising 1.

Example 19. The apparatus of any of examples 1 to 18, wherein the apparatus is further caused to: generate sparse principal components of a neural network.

Example 20. The apparatus of any of examples 1 to 19, wherein the mean matrix, the principal components matrix, and the row projection matrix are encoded as a codebook into or along the bitstream.

Example 21. The apparatus of any of examples 1 to 20, wherein the height and the width of the original input matrix is derived from a height and a width of the at least one input image.

Example 22. The apparatus of any of examples 1 to 21, wherein the at least one input tensor has a shape of CxHxW, where C is the channel dimension of the at least one input tensor, H is the height of the original input matrix, and W is the width of the original input matrix, wherein the original input matrix has a shape of HxW.

Example 23. An apparatus including: at least one processor; and at least one memory storing instructions that, when executed by the at least one processor, cause the apparatus at least to: decode, from or along a bitstream, a mean matrix, a principal components matrix, and a row projection matrix; wherein the mean matrix corresponds to a mean of training data matrices, wherein the training data matrices are respective slices of at least one input tensor along a channel dimension of the at least one input tensor; wherein an original input matrix is a slice of the at least one input tensor along the channel dimension of the at least one input tensor, wherein the original input matrix has dimensions comprising at least a height and a width; wherein the at least one input tensor corresponds to at least one input image; wherein the row projection matrix comprises a concatenation of row projection vectors; and reconstruct the original input matrix by adding the mean matrix to a product comprising a multiplication of the principal components matrix with a transpose of the row projection matrix.

Example 24. The apparatus of example 23, wherein: each row projection vector has a dimension corresponding to the width of the original input matrix; the number of row projection vectors comprises a row dimension of the row projection matrix; the row dimension of the row projection matrix is smaller than the width of the original input matrix; and the row projection matrix comprises dimensions corresponding to the width of the original input matrix and the row dimension.

Example 25. The apparatus of example 24, wherein the principal components matrix comprises a dimension corresponding to at least the row dimension of the row projection matrix.

Example 26. The apparatus of any of examples 23 to 25, wherein the mean matrix and the row projection matrix that are decoded from or along the bitstream are derived from one frame, and the mean matrix and the row projection matrix are used to reconstruct another frame different from the one frame, such that the mean matrix and the row projection matrix are derived from an intra frame, and the mean matrix and the row projection matrix are used for inter frames.

Example 27. The apparatus of any of examples 23 to 26, wherein the apparatus is further caused to: decode, from or along the bitstream, a column projection matrix; wherein the column projection matrix comprises a concatenation of column projection vectors; wherein the original input matrix is reconstructed by adding the mean matrix to a product comprising a multiplication of: the column projection matrix with the principal components matrix and with the transpose of the row projection matrix.

Example 28. The apparatus of example 27, wherein: each column projection vector has a dimension corresponding to the height of the original input matrix; the number of column projection vectors comprises a column dimension of the column projection matrix; the column dimension of the column projection matrix is smaller than the height of the original input matrix; and the column projection matrix comprises dimensions corresponding to the height of the original input matrix and the column dimension.

Example 29. The apparatus of example 28, wherein the principal components matrix comprises a dimension corresponding to at least the column dimension of the column projection matrix.

Example 30. The apparatus of any of examples 27 to 29, wherein the mean matrix, the row projection matrix, and the column projection matrix that are decoded from or along the bitstream are derived from one frame, and the mean matrix, the row projection matrix, and the column projection matrix are used to reconstruct another frame different from the one frame, such that the mean matrix, the row projection matrix, and the column projection matrix are derived intra frame, and the mean matrix, the row projection matrix, and the column projection matrix are used for inter frames.

Example 31. The apparatus of any of examples 23 to 30, wherein: the at least one input tensor comprises a matrix of channelwise pixel vectors; the channelwise pixel vectors are combined into the matrix of channelwise pixel vectors, wherein each channelwise pixel vector of the channelwise pixel vectors has a size; and a number of the channelwise pixel vectors in the matrix of channelwise pixel vectors corresponds to the height of the original input matrix multiplied by the width of the original input matrix.

Example 32. The apparatus of example 31, wherein the size of each channelwise pixel vector corresponds to the channel dimension of the at least one input tensor.

Example 33. The apparatus of any of examples 31 to 32, wherein the at least one input tensor has a first dimension comprising HxW and a second dimension comprising C, where C is the channel dimension of the at least one input tensor, and the original input matrix has a first dimension comprising HxW and a second dimension comprising 1.

Example 34. The apparatus of any of examples 23 to 33, wherein the apparatus is further caused to: decode sparse principal components of a neural network.

Example 35. The apparatus of any of examples 23 to 34, wherein the apparatus is further caused to: decode the mean matrix, the principal components matrix, and the row projection matrix from codebook from or along the bitstream.

Example 36. The apparatus of any of examples 23 to 35, wherein the height and the width of the original input matrix is derived from a height and a width of the at least one input image.

Example 37. The apparatus of any of examples 23 to 36, wherein the at least one input tensor has a shape of CxHxW, where C is the channel dimension of the at least one input tensor, H is the height of the original input matrix, and W is the width of the original input matrix, wherein the original input matrix has a shape of HxW.

Example 38. An apparatus including: at least one processor; and at least one memory storing instructions that, when executed by the at least one processor, cause the apparatus at least to: determine an input tensor; determine, from the input tensor, a mean matrix; wherein the input tensor corresponds to at least one input image; determine a row projection matrix by performing a left or right eigen decomposition on the mean matrix or on data derived from the mean matrix; determine, from the row projection matrix, a principal components matrix; and encode the mean matrix, the row projection matrix, and the principal components matrix into or along a bitstream.

Example 39. The apparatus of example 38, wherein the mean matrix and the row projection matrix are derived from one frame, and the mean matrix and the row projection matrix are used for another frame different from the one frame, such that the mean matrix and the row projection matrix are derived from an intra frame, and the mean matrix and the row projection matrix are used for inter frames.

Example 40. The apparatus of any of examples 38 to 39, wherein the apparatus is further caused to: determine a column projection matrix by performing a left or right eigen decomposition on the mean matrix or on data derived from the mean matrix; and encode the column projection matrix into or along the bitstream; wherein the principal components matrix that is encoded into or along the bitstream is further determined from the column projection matrix.

Example 41. The apparatus of example 40, wherein: when the row projection matrix is determined by performing the left eigen decomposition on the mean matrix or on data derived from the mean matrix, the column projection matrix is determined by performing the right eigen decomposition on the mean matrix or data derived from the mean matrix; and when the row projection matrix is determined by performing the right eigen decomposition on the mean matrix or on data derived from the mean matrix, the column projection matrix is determined by performing the left eigen decomposition on the mean matrix or data derived from the mean matrix.

Example 42. The apparatus of any of examples 40 to 41, wherein the mean matrix, the row projection matrix, and the column projection matrix are derived from one frame, and the mean matrix, the row projection matrix, and the column projection matrix are used for another frame different from the one frame, such that the mean matrix, the row projection matrix, and the column projection matrix are derived from an intra frame, and the mean matrix, the row projection matrix, and the column projection matrix are used for inter frames.

Example 43. The apparatus of any of examples 38 to 42, wherein the mean matrix corresponds to a mean of training data matrices, wherein the training data matrices are respective slices of the input tensor along a channel dimension of the at least one input tensor.

Example 44. The apparatus of any of examples 38 to 43, wherein the apparatus is further caused to: combine channelwise pixel vectors into a matrix of channelwise pixel vectors, wherein each channelwise pixel vector of the channelwise pixel vectors has a size comprising a channel size; wherein a number of the channelwise pixel vectors in the matrix corresponds to the height of a pixel multiplied by a width of the pixel; wherein the pixel corresponds to one channelwise pixel vector of the channelwise pixel vectors; wherein the input tensor from which the mean matrix is derived comprises the matrix of channelwise pixel vectors.

Example 45. An apparatus including: at least one processor; and at least one memory storing instructions that, when executed by the at least one processor, cause the apparatus at least to: decode, from or along a bitstream, a mean matrix, a principal components matrix, and a row projection matrix; and reconstruct an original input matrix by adding the mean matrix to a product comprising a multiplication of the principal components matrix with a transpose of the row projection matrix; wherein the original input matrix corresponds to an input tensor, and the input tensor corresponds to at least one image.

Example 46. The apparatus of example 45, wherein the apparatus is further caused to: decode, from or along the bitstream, a column projection matrix; wherein the original input matrix is reconstructed by adding the mean matrix to a product comprising a multiplication of: the column projection matrix with the principal components matrix and with the transpose of the row projection matrix.

Example 47. A method including: determining at least one input tensor; determining an original input matrix that is a slice of the at least one input tensor along a channel dimension of the at least one input tensor, wherein the original input matrix has dimensions comprising at least a height and a width; determining a mean matrix corresponding to a mean of training data matrices, wherein the training data matrices are respective slices of the at least one input tensor along the channel dimension of the at least one input tensor; wherein the at least one input tensor corresponds to at least one input image; determining a row projection matrix as a concatenation of row projection vectors; determining a difference by subtracting the mean matrix from the original input matrix; determining a principal components matrix by multiplying the difference obtained by subtracting the mean matrix from the original input matrix with the row projection matrix; and encoding the mean matrix, the principal components matrix, and the row projection matrix into or along a bitstream.

Example 48. A method including: decoding, from or along a bitstream, a mean matrix, a principal components matrix, and a row projection matrix; wherein the mean matrix corresponds to a mean of training data matrices, wherein the training data matrices are respective slices of at least one input tensor along a channel dimension of the at least one input tensor; wherein an original input matrix is a slice of the at least one input tensor along the channel dimension of the at least one input tensor, wherein the original input matrix has dimensions comprising at least a height and a width; wherein the at least one input tensor corresponds to at least one input image; wherein the row projection matrix comprises a concatenation of row projection vectors; and reconstructing the original input matrix by adding the mean matrix to a product comprising a multiplication of the principal components matrix with a transpose of the row projection matrix.

Example 49. A method including: determining an input tensor; determining, from the input tensor, a mean matrix; wherein the input tensor corresponds to at least one input image; determining a row projection matrix by performing a left or right eigen decomposition on the mean matrix or on data derived from the mean matrix; determining, from the row projection matrix, a principal components matrix; and encode the mean matrix, the row projection matrix, and the principal components matrix into or along a bitstream.

Example 50. A method including: decoding, from or along a bitstream, a mean matrix, a principal components matrix, and a row projection matrix; and reconstructing an original input matrix by adding the mean matrix to a product comprising a multiplication of the principal components matrix with a transpose of the row projection matrix; wherein the original input matrix corresponds to an input tensor, and the input tensor corresponds to at least one image.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

The term “non-transitory,” as used herein, is a limitation of the medium itself (i.e., tangible, not a signal) as opposed to a limitation on data storage persistency (e.g., RAM vs. ROM).

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even when the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows (the abbreviations may be appended with each other or with other characters using e.g. a hyphen, dash (-), or number (or abbreviations having a character may be the same with a character removed), and may be case insensitive):

| | |
|---|---|
| 1D | one-dimensional |
| 2D | two-dimensional |
| 2DPCA | two-dimensional PCA |
| 2D²PCA | two-dimensional PCA with reduction across row and column |
| | dimensions |
| 3D | three-dimensional |
| ASIC | application specific integrated circuit |
| BGR | blue green red |
| BV | basis vector |
| CC | character code |
| CE | core experiment |
| CfP | call for proposals |
| conv | convolutional |
| CPU | central processing unit |
| CTTC | common training and test condition |
| DCT | Discrete Cosine Transform |
| FCM | feature compression for machines |
| FPGA | field programmable gate array |
| FPN | feature pyramid network |
| GPU | graphics processing unit |
| H | height |
| HMD | head-mounted display |
| I/F | interface |
| Inv. | inverse |
| I/O | input/output |
| MC | mean centered |
| MPEG | moving picture experts group |
| NN | neural network |
| N/W | network |
| PCA | principal components/component analysis |
| PoC | proof of concept |
| RAM | random access memory |
| RCNN | regions with convolutional neural networks |
| res | residual |
| ResNet | residual neural network |
| RFM | reference frame memory |
| ROM | read only memory |
| SFU-HW | object labeled dataset on raw video sequences developed by |
| | Simon Fraser University |
| SON | self-organizing/optimizing network |
| SVD | singular value decomposition |
| UI | user interface |
| USB | universal serial bus |
| VTM | VVC Test model |
| VVC | versatile video coding |
| W | width |

What is claimed is:

1. An apparatus comprising: at least one processor; and at least one memory storing instructions that, when executed by the at least one processor, cause the apparatus at least to: decode, from or along a bitstream, a mean matrix, a principal components matrix, and a row projection matrix; wherein the mean matrix corresponds to a mean of training data matrices, wherein the training data matrices are respective slices of at least one input tensor along a channel dimension of the at least one input tensor; wherein an original input matrix is a slice of the at least one input tensor along the channel dimension of the at least one input tensor, wherein the original input matrix has dimensions comprising at least a height and a width; wherein the at least one input tensor corresponds to at least one input image; wherein the row projection matrix comprises a concatenation of row projection vectors; and reconstruct the original input matrix by adding the mean matrix to a product comprising a multiplication of the principal components matrix with a transpose of the row projection matrix.

2. The apparatus of claim 1, wherein: each row projection vector has a dimension corresponding to the width of the original input matrix; the number of row projection vectors comprises a row dimension of the row projection matrix; the row dimension of the row projection matrix is smaller than the width of the original input matrix; and the row projection matrix comprises dimensions corresponding to the width of the original input matrix and the row dimension.

3. The apparatus of claim 2, wherein the principal components matrix comprises a dimension corresponding to at least the row dimension of the row projection matrix.

4. The apparatus of claim 1, wherein the mean matrix and the row projection matrix that are decoded from or along the bitstream are derived from one frame, and the mean matrix and the row projection matrix are used to reconstruct another frame different from the one frame, such that the mean matrix and the row projection matrix are derived from an intra frame, and the mean matrix and the row projection matrix are used for inter frames.

5. The apparatus of claim 1, wherein the apparatus is further caused to: decode, from or along the bitstream, a column projection matrix; wherein the column projection matrix comprises a concatenation of column projection vectors; wherein the original input matrix is reconstructed by adding the mean matrix to a product comprising a multiplication of: the column projection matrix with the principal components matrix and with the transpose of the row projection matrix.

6. The apparatus of claim 5, wherein: each column projection vector has a dimension corresponding to the height of the original input matrix; the number of column projection vectors comprises a column dimension of the column projection matrix; the column dimension of the column projection matrix is smaller than the height of the original input matrix; and the column projection matrix comprises dimensions corresponding to the height of the original input matrix and the column dimension.

7. The apparatus of claim 6, wherein the principal components matrix comprises a dimension corresponding to at least the column dimension of the column projection matrix.

8. The apparatus of claim 5, wherein the mean matrix, the row projection matrix, and the column projection matrix that are decoded from or along the bitstream are derived from one frame, and the mean matrix, the row projection matrix, and the column projection matrix are used to reconstruct another frame different from the one frame, such that the mean matrix, the row projection matrix, and the column projection matrix are derived intra frame, and the mean matrix, the row projection matrix, and the column projection matrix are used for inter frames.

9. The apparatus of claim 1, wherein: the at least one input tensor comprises a matrix of channelwise pixel vectors; the channelwise pixel vectors are combined into the matrix of channelwise pixel vectors, wherein each channelwise pixel vector of the channelwise pixel vectors has a size; and a number of the channelwise pixel vectors in the matrix of channelwise pixel vectors corresponds to the height of the original input matrix multiplied by the width of the original input matrix.

10. An apparatus comprising: at least one processor; and at least one memory storing instructions that, when executed by the at least one processor, cause the apparatus at least to: decode, from or along a bitstream, a mean matrix, a principal components matrix, and a row projection matrix; and reconstruct an original input matrix by adding the mean matrix to a product comprising a multiplication of the principal components matrix with a transpose of the row projection matrix; wherein the original input matrix corresponds to an input tensor, and the input tensor corresponds to at least one image.

11. The apparatus of claim 10, wherein the apparatus is further caused to: decode, from or along the bitstream, a column projection matrix; wherein the original input matrix is reconstructed by adding the mean matrix to a product comprising a multiplication of: the column projection matrix with the principal components matrix and with the transpose of the row projection matrix.

12. An apparatus comprising: at least one processor; and at least one memory storing instructions that, when executed by the at least one processor, cause the apparatus at least to: determine at least one input tensor; determine an original input matrix that is a slice of the at least one input tensor along a channel dimension of the at least one input tensor, wherein the original input matrix has dimensions comprising at least a height and a width; determine a mean matrix corresponding to a mean of training data matrices, wherein the training data matrices are respective slices of the at least one input tensor along the channel dimension of the at least one input tensor; wherein the at least one input tensor corresponds to at least one input image; determine a row projection matrix as a concatenation of row projection vectors; determine a difference by subtracting the mean matrix from the original input matrix; determine a principal components matrix by multiplying the difference obtained by subtracting the mean matrix from the original input matrix with the row projection matrix; and encode the mean matrix, the principal components matrix, and the row projection matrix into or along a bitstream.

13. The apparatus of claim 12, wherein the apparatus is further caused to: determine a number of the row projection vectors, where each row projection vector has a dimension corresponding to the width of the original input matrix; wherein the number of the row projection vectors comprises a row dimension of the row projection matrix; wherein the row dimension of the row projection matrix is smaller than the width of the original input matrix; wherein the row projection matrix comprises dimensions corresponding to the width of the original input matrix and the row dimension.

14. The apparatus of claim 13, wherein the principal components matrix comprises a dimension corresponding to at least the row dimension of the row projection matrix.

15. The apparatus of claim 12, wherein the apparatus is further caused to determine a row projection vector of the row projection vectors with: determining at least one parameter that maximizes a transpose of the row projection vector multiplied with a training data covariance matrix multiplied with the row projection vector; wherein the training data covariance matrix is a square matrix comprising dimensions corresponding to the width of the original input matrix; wherein the transpose of the row projection vector multiplied with another row projection vector of the row projection vectors is equal to zero, wherein the another row projection vector is any of the row projection vectors other than the row projection vector, such that the row projection vector is orthogonal to the other row projection vectors.

16. The apparatus of claim 15, wherein apparatus is further caused to determine the training data covariance matrix with: determining, for each training data matrix of the training data matrices, a product comprising a transpose of the training data matrix minus the mean matrix multiplied with the training data matrix minus the mean matrix; wherein the training data covariance matrix comprises a sum of the products divided by a number of the training data matrices.

17. The apparatus of claim 15, wherein determining the at least one parameter that maximizes the transpose of the row projection vector multiplied with the training data covariance matrix multiplied with the row projection vector comprises computing a number of eigenvectors of the training data covariance matrix corresponding to a number of largest eigenvalues, wherein the number of eigenvectors is a row dimension of the row projection matrix, and wherein the number of largest eigenvalues is the row dimension of the row projection matrix, wherein the row dimension of the row projection matrix is smaller than the width of the original input matrix.

18. The apparatus of claim 12, wherein the mean matrix and the row projection matrix are derived from one frame, and the mean matrix and the row projection matrix are used for another frame different from the one frame, such that the mean matrix and the row projection matrix are derived from an intra frame, and the mean matrix and the row projection matrix are used for inter frames.

19. The apparatus of claim 12, wherein the apparatus is further caused to: determine a column projection matrix as a concatenation of column projection vectors; and encode the column projection matrix into or along the bitstream.

20. The apparatus of claim 19, wherein the principal components matrix is further determined by multiplying a transpose of the column projection matrix with: the difference obtained by subtracting the mean matrix from the original input matrix, and with the row projection matrix.
